(19) United States
(12) Patent Application Publication
(10) Pub. No.: US 2013/0291500 A1
(43) Pub. Date: Nov. 7, 2013

(54) AIR CLEANER WITH INTEGRATED RESONATOR

(71) Applicant: Harold V. Rodabaugh, Davison, MI (US)

(72) Inventor: Harold V. Rodabaugh, Davison, MI (US)

(73) Assignee: GM GLOBAL TECHNOLOGY OPERATIONS LLC, Detroit, MI (US)

(21) Appl. No.: 13/490,878

(22) Filed: Jun. 7, 2012

Related U.S. Application Data
(60) Provisional application No. 61/641,938, filed on May 3, 2012.

(51) Int. Cl. B01D 45/08; B29C 45/14

(52) U.S. Cl. 55/462; 264/259

(57) ABSTRACT

An air cleaner assembly includes an air cleaner cover and a resonator. The air cleaner cover includes an air outlet having a receiving portion configured to receive a resonator. The resonator may be disposed within the receiving portion of the air outlet, and may include a plurality of concentric baffles defining an inner flow path, and an inner skin circumferentially disposed about the inner flow path and in contact with a the plurality of concentric baffles. The inner skin may define at least one opening. The inner skin, the plurality of concentric baffles, and an inner surface of the receiving portion may cooperate to define at least one back volume. The at least one back volume may be in fluid communication with the inner flow path through the at least one opening.

### CROSS REFERENCE TO RELATED APPLICATIONS

This application claims the benefit of U.S. Provisional Application No. 61/641,938, filed May 3, 2012, which is hereby incorporated by reference in its entirety.

### TECHNICAL FIELD

The present invention relates generally to vehicle air cleaner assemblies.

### BACKGROUND

Forced-air induction systems allow vehicle engines to increase their volumetric efficiency and power output by compressing a greater mass of air and fuel into a combustion cylinder prior to ignition. Such systems include a compressor positioned between an air cleaner assembly and an intake manifold of the engine. Due to the dynamics of the compressor and the engine intake valves, forced-air intake systems tend to emit a high-frequency sound that may travel in an upstream direction from the compressor (i.e., through the air cleaner assembly and intake), and may be perceived by occupants of the vehicle and/or bystanders. In some circumstances, this high-frequency sound may be undesirable.

### SUMMARY

An air cleaner assembly includes an air cleaner cover and a resonator. The air cleaner cover includes an air outlet having a receiving portion configured to receive a resonator. The resonator may be disposed within the receiving portion of the air outlet, and may include a plurality of concentric baffles defining an inner flow path, and an inner skin circumferentially disposed about the inner flow path and in contact with a the plurality of concentric baffles. The inner skin may define at least one opening. The inner skin, the plurality of concentric baffles, and an inner surface of the receiving portion may cooperate to define at least one back volume. The at least one back volume may be in fluid communication with the inner flow path through the at least one opening. In one configuration, the air outlet may be integrally formed with the air cleaner cover through injection molding.

The at least one back volume and at least one opening cooperate to attenuate sound energy transmitted through the inner flow path. In one configuration, the dimensions of the at least one back volume and at least one opening are configured to attenuate sound energy having a frequency between 1 kHz and 20 kHz. In another configuration, the dimensions of the at least one back volume and at least one opening are configured to attenuate sound energy having a frequency between 1 kHz and 4 kHz.

The air cleaner assembly may further include a duct having an enlarged coupling portion configured to circumferentially extend around, and couple with the air outlet. The duct may further include a second end that is opposite the enlarged coupling portion, and which is configured to couple with a compressor. As such, the duct may fluidly couple the inner flow path with the compressor.

The above features and advantages and other features and advantages of the present invention are readily apparent from the following detailed description of the best modes for carrying out the invention when taken in connection with the accompanying drawings.

### BRIEF DESCRIPTION OF THE DRAWINGS

FIG. 1 is a schematic partial cross-sectional diagram of a vehicle engine.

FIG. 2 is a schematic exploded perspective view of an air cleaner assembly with an integral resonator.

FIG. 3 is a schematic perspective view of a resonator.

### DETAILED DESCRIPTION

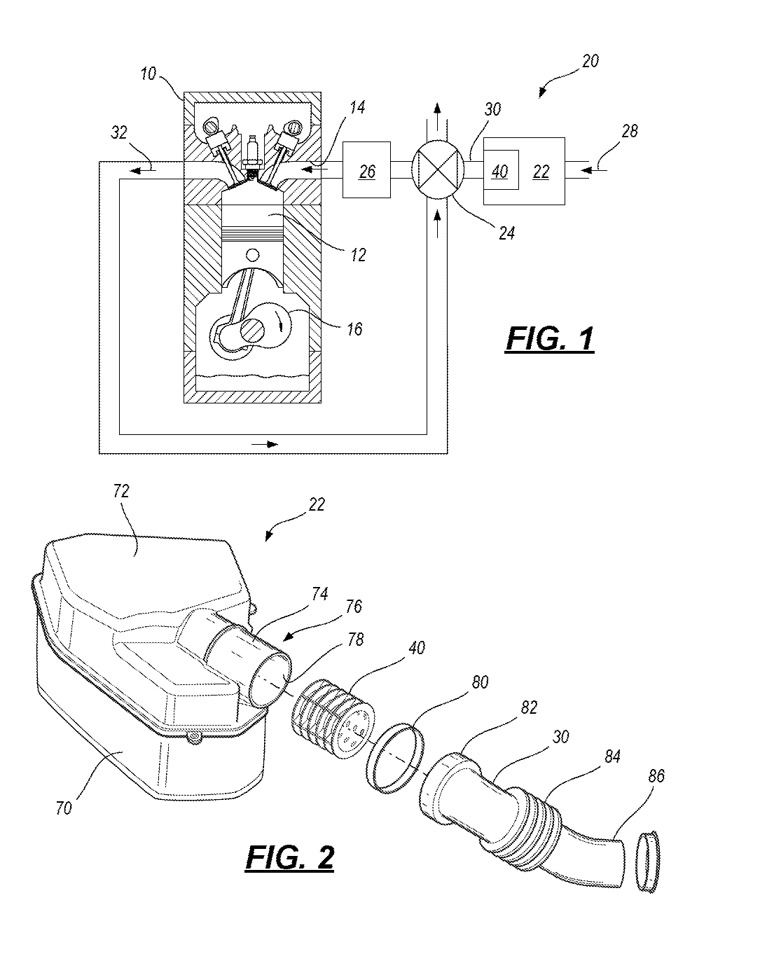

Referring to the drawings, wherein like reference numerals are used to identify like or identical components in the various views, FIG. 1 schematically illustrates a vehicle engine 10 partially defining a combustion chamber 12, an intake port 14, and an exhaust port. As is typical in the art, fresh air (and fuel) is supplied to the combustion chamber 12 via the intake port 14 where it is combusted to rotate a crankshaft 16.

Following the combustion, the hot exhaust gasses are expelled from the combustion chamber 12 via the exhaust port. The vehicle engine 10 may be an internal combustion engine (ICE) that may operate either on the principle of spark-ignition (as with a typical gasoline engine), or on the principle of compression-ignition (as with a typical diesel engine).

The vehicle engine 10 may be in communication with an air intake system 20 that includes an air cleaner assembly 22, a compressor 24, and an intake manifold 26. Fresh air (generally represented by arrow 28) may be drawn in through the air cleaner assembly 22, where particulate debris and/or dust may be removed. The air cleaner assembly 22 may include one or more porous filters that may be permeable by air, yet adapted to restrict the passage of other suspended object/compounds.

Following the air cleaner assembly 22, the fresh air 28 may pass through a duct 30 en route to a compressor 24. The compressor 24 may increase the pressure of the fresh air to feed more air/oxygen into the combustion chamber 12. This process may in turn cause an increase the volumetric efficiency and power output of the engine 10. As schematically illustrated, the compressor 24 may be a component of a turbocharger, which uses the exhaust flow 32 to power the compressor. Alternatively, the compressor 24 may be driven by the crankshaft, such as in a supercharger. While a single turbocharged intake assembly is schematically depicted in FIG. 1, the system may similarly be configured to use multiple turbochargers/superchargers in various configurations as known in the art. Following the compressor 24, the air may pass through the intake manifold 26 and then into the combustion chamber 12 via the intake port 14.

During operation of the engine 12, noise may be generated by the introduction of fresh air 28 into the air intake system 20 though an acoustic phenomena known as “intake pulsing.” This noise may be further amplified by the use of the compressor 24 to generate the corresponding pressure boost. To counteract, attenuate, and/or absorb the intake pulsing sound energy, a resonator 40 may be integrated into the air cleaner assembly 22, as will be described in greater detail below. As may be appreciated, induction tuning of the air intake system 20 may not only reduce unwanted noise, but it may also maximize air flow by minimizing or counteracting the effects of standing waves and other acoustic phenomena generated in the air intake system 20.

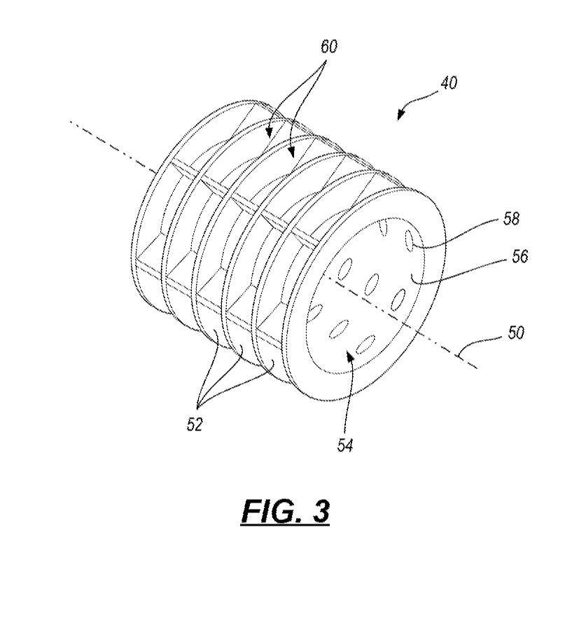

FIGS. 2-3 more clearly illustrate one configuration of a resonator 40 that may be integrated within an air cleaner assembly 22. In one configuration, the resonator 40 may be a “Helmholtz Resonator”, which may utilize the Helmholtz resonance phenomena to counteract or attenuate unwanted air intake noise. Referring to FIG. 3, the resonator 40 may be disposed about an axis 50, and may include a plurality of concentric baffles 52. The baffles 52 may be any suitable shape, including, for example, and without limitation, circular, rectangular, pentagonal, hexagonal, and/or octagonal. The plurality of concentric baffles may define an inner flow channel 54, which may be lined with an inner skin 56. The inner skin 56 may include a plurality of openings 58 or perforations that may allow the restricted passage of air between the inner flow channel 54 and one or more back volumes 60 that are partially defined by the baffles 52 and the inner skin 56. In one configuration, the inner flow channel 54 may have a diameter of approximately 55-75 mm.

Referring again to FIG. 2, the resonator 40 may be configured to be inserted within an air cleaner assembly 22. As shown, the air cleaner assembly 22 may include a body 70 and a cover 72 that may cooperate to define an air cleaner volume. The cover 72 may be an injection molded component that may be formed from, for example, a polypropylene material. The air cleaner assembly 22 may include an air inlet (not shown) and an air outlet 74 that are each in fluid communication with the air cleaner volume. The air inlet may allow unfiltered fresh air to be received by the air cleaner assembly 22, while the air outlet 74 may allow filtered air to pass to the remainder of the intake system 20 and the vehicle engine 10. A filter media (not shown) may be disposed within the air cleaner volume between the air inlet and the air outlet 74. The filter media may be a standard vehicle air filter that is configured to filter out suspended dust, debris, and/or particulate from the fresh air. In one configuration, as generally shown in FIG. 2, the air outlet 74 may be entirely defined by the cover 72.

As further illustrated in FIG. 2, the air outlet 74 may include a receiving portion 76 that is dimensioned to accept the resonator 40 within the integrally molded walls of the air outlet 74. When the resonator 40 is installed within the receiving portion 76 of the air outlet 74, an inner surface 78 of the air outlet 74/cover 72 may cooperate with the inner skin 56 and the plurality of concentric baffles 52 of the resonator 40 to define the at least one back volume 60. In one configuration, the back volume 60 defined by the inner surface 78, inner skin 56, and the plurality of concentric baffles 52 may be in fluid communication with only the inner flow channel 54 (via the plurality of openings 58). Additionally, the inner flow channel 54 of the resonator 40 may be the sole flow-path out of the air cleaner assembly 22.

Following the installation of the resonator 40 within the receiving portion 76, a duct 30 may be coupled with the air outlet 74, such as through the use of one or more clips 80. In one configuration, such as generally illustrated in FIG. 2, the duct 30 may be configured with a enlarged coupling portion 82 that may slip over the air outlet 74. Once in place, the duct 30 may be secured in place via one or more tabs, screws, c-clips, or other similar fastening devices. The duct 30 may include a series of bellows 84, which may permit the duct 30 to flex, stretch, and/or compress in a manner that may permit relative motion between the air cleaner assembly 22 and the compressor 24 (which may be coupled to a second end 86 of the duct 30.

The resonator 40 may be specifically tuned to resonate out of phase with the intake pulsing generated/amplified by the compressor 24. As known in the art, tuning may be accomplished by manipulating the physical dimensions of the one or more back volumes 60 along as by manipulating the size of the plurality of openings/holes 58 in the inner skin 56 that lead to the back volumes 60. In one configuration, the resonator 40 may be tuned to attenuate audible frequencies between approximately 1 kHz and approximately 20 kHz. In another configuration, the resonator may be tuned to attenuate audible frequencies between approximately 1.0 kHz and approximately 4.0 kHz.

By integrally disposing the resonator 40 within the air cleaner assembly 22, noise generated via the intake assembly may be substantially attenuated before the sound waves are able to freely exit the system. Furthermore, including the resonator as a component of the air cleaner assembly 22 may have distinct advantages over a system where the resonator is an ancillary and/or downstream component. For example, such an integral design may reduce packaging size of the intake assembly, may reduce component interconnections, and may reduce the potential for air leaks.

While the best modes for carrying out the invention have been described in detail, those familiar with the art to which this invention relates will recognize various alternative designs and embodiments for practicing the invention within the scope of the appended claims. It is intended that all matter contained in the above description or shown in the accompanying drawings shall be interpreted as illustrative only and not as limiting.

1. An air cleaner assembly comprising:
an air cleaner cover including an air outlet, the air outlet including a receiving portion configured to receive a resonator, the receiving portion having an inner surface;
a resonator disposed within the receiving portion of the air outlet, the resonator including:
a plurality of concentric baffles defining an inner flow path;
an inner skin circumferentially disposed about the inner flow path and in contact with the plurality of concentric baffles, the inner skin defining at least one opening;
wherein the inner skin, the plurality of concentric baffles, and the inner surface of the receiving portion cooperate to define at least one back volume; and
wherein the at least one back volume is in fluid communication with the inner flow path through the at least one opening.

2. The assembly of claim 1, wherein the at least one back volume and at least one opening cooperate to attenuate sound energy transmitted through the inner flow path.

3. The assembly of claim 2, wherein the dimensions of the at least one back volume and at least one opening are configured to attenuate sound energy having a frequency between 1 kHz and 20 kHz.

4. The assembly of claim 2, wherein the dimensions of the at least one back volume and at least one opening are configured to attenuate sound energy having a frequency between 1 kHz and 4 kHz.

5. The assembly of claim 1, further comprising a duct including an enlarged coupling portion configured to circumferentially extend around, and couple with the air outlet.

6. The assembly of claim 5, wherein the duct includes a second end that is opposite the enlarged coupling portion, the second end configured to couple with a compressor; and
wherein the duct fluidly couples the inner flow path with the compressor.

7. The assembly of claim 1, wherein the air outlet is integrally formed with the air cleaner cover through injection molding.

8. An air cleaner assembly comprising:
an air cleaner cover including an air outlet, the air outlet including a receiving portion configured to receive a resonator, the receiving portion having an inner surface;
a resonator disposed within the receiving portion of the air outlet, the resonator including:
a plurality of concentric baffles defining an inner flow path;
an inner skin circumferentially disposed about the inner flow path and in contact with the plurality of concentric baffles, the inner skin defining at least one opening;
wherein the inner skin, the plurality of concentric baffles, and the inner surface of the receiving portion cooperate to define at least one back volume;
wherein the at least one back volume is in fluid communication with the inner flow path through the at least one opening; and
wherein the at least one back volume and at least one opening cooperate to attenuate sound energy transmitted through the inner flow path.

9. The assembly of claim 8, wherein the dimensions of the at least one back volume and at least one opening are configured to attenuate sound energy having a frequency between 1 kHz and 20 kHz.

10. The assembly of claim 8, wherein the dimensions of the at least one back volume and at least one opening are configured to attenuate sound energy having a frequency between 1 kHz and 4 kHz.

11. The assembly of claim 8, further comprising a duct including an enlarged coupling portion configured to circumferentially extend around, and couple with the air outlet.

12. The assembly of claim 11, wherein the duct includes a second end that is opposite the enlarged coupling portion, the second end configured to couple with a compressor; and
wherein the duct fluidly couples the inner flow path with the compressor.

13. The assembly of claim 8, wherein the air outlet is integrally formed with the air cleaner cover through injection molding.

14. An air cleaner assembly comprising:
an air cleaner cover having an integrally formed an air outlet, the air outlet including a receiving portion configured to receive a resonator, the receiving portion having an inner surface;
a duct including an enlarged coupling portion configured to circumferentially extend around, and couple with the air outlet;
a resonator disposed within the receiving portion of the air outlet, the resonator including:
a plurality of concentric baffles defining an inner flow path;
an inner skin circumferentially disposed about the inner flow path and in contact with the plurality of concentric baffles, the inner skin defining at least one opening;
wherein the inner skin, the plurality of concentric baffles, and the inner surface of the receiving portion cooperate to define at least one back volume;
wherein the at least one back volume is in fluid communication with the inner flow path through the at least one opening; and
wherein the at least one back volume and at least one opening cooperate to attenuate sound energy transmitted through the inner flow path.

15. The assembly of claim 14, wherein the dimensions of the at least one back volume and at least one opening are configured to attenuate sound energy having a frequency between 1 kHz and 20 kHz.

16. The assembly of claim 14, wherein the dimensions of the at least one back volume and at least one opening are configured to attenuate sound energy having a frequency between 1 kHz and 4 kHz.

17. The assembly of claim 14, wherein the duct includes a second end that is opposite the enlarged coupling portion, the second end configured to couple with a compressor; and
wherein the duct fluidly couples the inner flow path with the compressor.

18. The assembly of claim 14, wherein the air outlet is integrally formed with the air cleaner cover through injection molding.
